(19) United States
(12) Patent Application Publication
(10) Pub. No.: US 2024/0316807 A1
(43) Pub. Date: Sep. 26, 2024

(54) A GUARD PLATE

(71) Applicant: KONINKLIJKE PHILIPS N.V., EINDHOVEN (NL)

(72) Inventors: JAN VAN DALEN, DONKERBROEK (NL); ROBERT GODLIEB, DRACHTEN (NL)

(21) Appl. No.: 18/578,038

(22) PCT Filed: Jul. 13, 2022
(86) PCT No.: PCT/EP2022/069630

§ 371 Date: Jan. 11, 2024

(30) Foreign Application Priority Data
Jul. 15, 2021 (EP) 21185741.2

(51) Int. Cl. B26B 19/38; B26B 19/12

(52) U.S. Cl. CPC B26B 19/382; B26B 19/12; B26B 19/3846

(57) ABSTRACT

According to an aspect, there is provided a guard plate (10) for a blade set (100) for a hair cutting appliance, the guard plate comprising a skin-facing side (12) and an opposing blade-facing side; a plurality of close-cutting trimming teeth (16) distributed in a longitudinal direction along an edge (18) of the guard plate, each tooth extending from the edge of the guard plate to a respective tip (20), the close-cutting trimming teeth having a thickness of less than (120) microns; a raised section (22) comprising a curved shape in a plane perpendicular to the longitudinal direction such that it is raised from the teeth towards the skin-facing side of the guard plate, wherein the curved shape of the raised section does not extend beyond a (30)-degree envelope defined by a line passing through the mg edge of the guard plate and offset from a tangent at the edge of the guard plate by (30) degrees; a pressure relenting zone (30) between the teeth and the raised section defining a continuous surface, wherein there is a transition (32) between the pressure relenting zone and the raised section such that, when the guard plate is passed over a user's taut skin, the skin does not directly follow the contours of the transition thereby locally reducing pressure from the skin; wherein a plurality of apertures (48) are distributed on the raised section at least within a pressure restoring zone (36) of the raised section, the pressure restoring zone being defined between a rising point and a tangent point, wherein the rising point is where a perpendicular distance from the skin-facing surface of the guard plate to a pressure relenting line peaks, wherein the pressure relenting line is defined by a tangent of the raised section in a plane perpendicular to the longitudinal direction, the tangent passing through the edge of the guard plate, and wherein the tangent point is on the raised section at the tangent of the pressure relenting line.

### FIELD OF THE INVENTION

The invention relates to a guard plate for a blade set for a hair cutting appliance and a blade set, a cutting unit, and hair cutting appliance comprising such a guard plate.

### BACKGROUND OF THE INVENTION

There are different types of facial hair cutters available, for example trimmers which comprise two sets of oscillating teeth on an edge of a plate, and foil-shavers which comprise a foil with apertures to receive hairs, and a blade to cut the hairs in the apertures. Typically foil-shavers enable a closer shave than trimmers do, but close-cutting trimmers which comprise a very thin plate comprising one set of teeth to lie against the skin can also achieve a very close shave.

Previously considered arrangements have not successfully combined the foil-shaver and a trimmer in a single unit, because the foil-shaver requires a domed shape for superior cutting performance, but the domed shape interferes with the continuous skin contact required on the teeth of the close-cutting trimmers for a close shave, thereby reducing the performance of the close-cutting trimmers.

WO2015158923 discloses a blade set having a curved guard plate comprising trimming teeth and an apertured foil.

### SUMMARY OF THE INVENTION

According to a first specific aspect, there is provided a guard plate for a blade set for a hair cutting appliance, the guard plate comprising a skin-facing side and an opposing blade-facing side: a plurality of close-cutting trimming teeth distributed in a longitudinal direction along an edge of the guard plate, each tooth extending from the edge of the guard plate to a respective tip, the close-cutting trimming teeth having a thickness of less than 120 microns; a raised section comprising a curved shape in a plane perpendicular to the longitudinal direction such that it is raised from the teeth towards the skin-facing side of the guard plate, wherein the curved shape of the raised section does not extend beyond a 30-degree envelope defined by a line passing through the edge of the guard plate and offset from a tangent at the edge of the guard plate by 30 degrees; a pressure relenting zone between the teeth and the raised section defining a continuous surface, wherein there is a transition between the pressure relenting zone and the raised section such that, when the guard plate is passed over a user's taut skin, the skin does not directly follow the contours of the transition thereby locally reducing pressure from the skin; wherein a plurality of apertures are distributed on the raised section at least within a pressure restoring zone of the raised section, the pressure restoring zone being defined between a rising point and a tangent point, wherein the rising point is where a perpendicular distance from the skin-facing surface of the guard plate to a pressure relenting line peaks, wherein the pressure relenting line is defined by a tangent of the raised section in a plane perpendicular to the longitudinal direction, the tangent passing through the edge of the guard plate, and wherein the tangent point is on the raised section at the tangent of the pressure relenting line.

The plurality of apertures may be distributed on the raised section at least within the first 1 mm of the pressure restoring zone from the rising point.

The surface of the guard plate at the transition may comprise a change in height of at least 0.1 mm, the height being defined by the perpendicular distance between the skin-facing surface and the pressure relenting line.

The plurality of apertures may be further distributed across a top portion of the raised section adjacent to the pressure restoring zone of the raised section.

The pressure relenting zone may be planar.

The guard plate may comprise a plurality of close-cutting trimming teeth distributed in the longitudinal direction along opposing edges of the guard plate. There may be a pair of pressure relenting zones located on either side of the raised section, each pressure relenting zone disposed between the raised section and the teeth along one edge of the guard plate. The raised section may comprise a top portion flanked by two pressure restoring zones, each pressure restoring zone adjacent to a pressure relenting zone, wherein the raised section comprises a plurality of apertures distributed in at least the two pressure restoring zones.

The guard plate may be formed of a single integral plate.

The curved shape of the raised section may extend beyond a 5-degree envelope defined by a line passing through the edge of the guard plate and offset from a tangent at the edge of the guard plate by 5 degrees.

Each tooth may extend from the edge to a tip, and at the tip, each tooth may be bent towards the blade-facing surface and directed back towards the edge, connecting to the blade-facing surface to form a buttress to reinforce the tooth.

The apertures may be evenly distributed across the pressure restoring zone. The proportion of the area of apertures to total area of the pressure restoring zone may be at least 40%.

According to a second aspect, there is provided a blade set for a hair cutting appliance comprising the guard plate according to the first aspect, and a cutting plate considered to be received on the guard plate and to cooperate with the guard plate to cut hair.

According to a third aspect, there is provided a cutting assembly comprising a blade set according to the second aspect, and a driving unit configured to oscillate the cutting plate with respect to the guard plate.

According to a fourth aspect, there is provided a hair cutting appliance comprising a cutting assembly according to the third aspect mounted on a handle.

These and other aspects will be apparent from and elucidated with reference to the embodiments described hereinafter.

### BRIEF DESCRIPTION OF THE DRAWINGS

Exemplary embodiments will now be described, by way of example only, with reference to the following drawings, in which:

FIG. 1 schematically shows a perspective view of an example guard plate;

FIG. 2 schematically shows a simplified side-view of the example guard plate of FIG. 1;

FIG. 3 schematically shows an exploded view of a blade set comprising the guard plate of FIGS. 1 and 2; and

FIG. 4 schematically shows a cross-sectional view of a cutting assembly comprising the blade set of FIG. 3 in use.

### DETAILED DESCRIPTION OF THE EMBODIMENTS

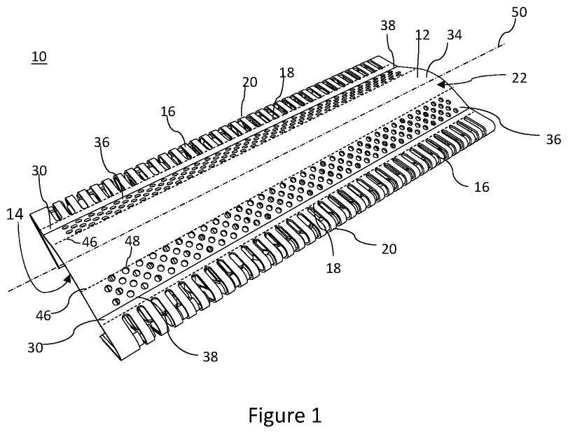

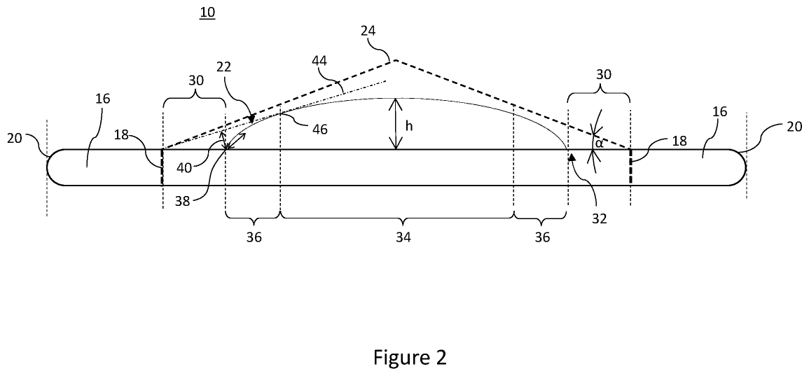

FIG. 1 shows an example guard plate 10 which is used in a hair cutting appliance for trimming hair, such as a beard trimmer, and FIG. 2 shows a simplified side-view of the geometry of the guard plate 10.

The guard plate 10 comprises a single integral plate having a skin-facing side 12 and an opposing blade-facing side 14. The guard plate 10 comprises a plurality of close-cutting trimming teeth 16 distributed in a longitudinal direction parallel to a longitudinal axis 50 along which the guard plate 10 extends.

Each close-cutting trimming tooth 16 extends from an edge of the guard plate 10 to a respective tip 20. At the tip 20 of each close-cutting tooth 16, the tooth 16 is bent towards the blade-facing surface 14 (i.e. away from the skin-facing surface 12) and back towards the edge 18 in a bent-back portion at which the teeth 16 join together again to form a continuous plate section.

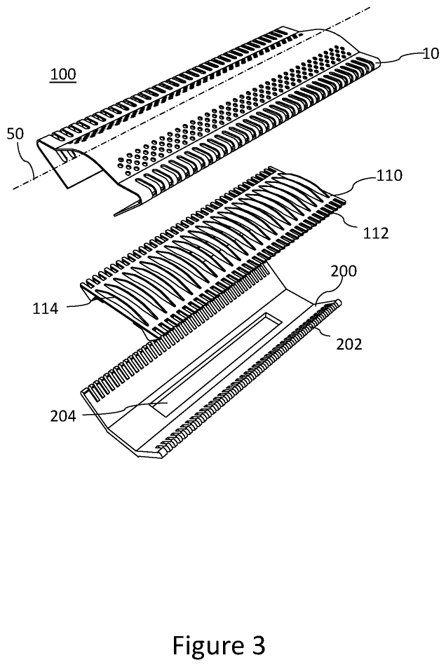

The close-cutting teeth 16 are configured to cooperate with cutting teeth 112 on a cutting plate 110 (described in more detail below with reference to FIG. 3) to cut hairs. The close-cutting trimming teeth 16 have a thickness (of the plate) of approximately 90 microns to ensure that the hair is cut as close as possible to the skin. In other examples, the close-cutting trimming teeth have a thickness of less than 100 microns, or less than 120 microns to ensure a close shave.

In this example, the close-cutting trimming teeth 16 are disposed on opposing edges of the guard plate 10 (i.e. on either side of the longitudinal axis 50) such that the guard plate 10 can be used to cut hairs in two different directions. In other examples, the close-cutting trimming teeth may be disposed only along one edge of the guard plate.

The guard plate 10 comprises a raised section 22 having a curved shape in a plane which is perpendicular to the longitudinal axis 50 (e.g. the plane shown in FIG. 2) and also perpendicular to the edges 18 of the guard plate 10 in this example. The raised section 22 is raised from the close-cutting trimming teeth 16 in a direction towards the skin-facing side 12 of the guard plate 10 (i.e. away from the blade-facing side 14). The shape of the guard plate in this example is constant along the longitudinal axis 50. In other examples, the shape of the guard plate may vary along the longitudinal axis.

The guard plate 10 further comprises a pair of pressure relenting zones 30 on either side of the raised section 22, each pressure relenting zone 30 disposed between one set of close-cutting teeth 16 along one edge 18 and the raised section 22. In this example, each pressure relenting zone 30 comprises a continuous planar section, approximately 1 mm long, of the plate between the respective close-cutting teeth 16 and the raised section 22. In other examples, the pressure relenting zone may define any continuous surface, and may be of any suitable length, such as less than 1 mm or more than 1 mm. In other examples, the pressure relenting zone is at least 0.3 mm long to ensure that there is sufficient pressure reduction on the skin in use.

In this example, the raised section 22 has a profile such that it has a height difference of approximately 1 mm from the pressure relenting zone 30. The raised section 22 is for a foil cutting element and improves the skin contact required for a close shave. In other examples, the raised section may have any suitable height difference from the pressure relenting zone, such as more or less than 1 mm, or at least 0.5 mm.

There is a transition 32 between each pressure relenting zone 30 and the raised section 22, such that each pressure relenting zone 30 is defined between a respective edge 18 of the guard plate 10 and the respective transition 32. The two transitions 32 in this example each comprise a recess with a sharp corner (i.e. a discontinuity). In other examples, the transitions may comprise a recess with a chamfered corner, or a culvert or channel in the otherwise planar or continuous surface from the pressure relenting zone. The transition may have any profile which withdraws from a skin-line which a user's skin would follow between the teeth and the raised section in use.

Each transition 32 ensures that, when the guard plate is passed over the user's taut skin in use, the skin does not directly follow the contours of the plate at the transition 32, such that the pressure on the user's skin applied by the guard plate 10 is reduced locally, or removed altogether, at the transition.

A pressure relenting line 44 is defined on either side of the raised section 22 by a tangent to the raised section 22 which passes through a respective edge 18 of the guard plate 10 in a plane perpendicular to the longitudinal axis 50 (only one pressure relenting line 44 is shown in FIG. 2).

The raised section 22 comprises a top portion 34 which is adjacent to, and flanked by, two pressure restoring zones 36. Each pressure restoring zone 36 is adjacent to a pressure relenting zone 30. The pressure restoring zones 36 are each defined between a rising point 38 (within the transition 32) and a tangent point 46 which is on the raised section 22 at the point where the pressure relenting line 44 meets the raised section 22. The rising point 38 is defined at the point on the guard plate 10 at which a perpendicular distance (shown by the arrow 40 in FIG. 2) between the pressure relenting line 44 and the skin-facing side 12 of the guard plate 10 peaks (i.e. reaches a maximum). In this example, the change in the perpendicular distance between the pressure relenting line 44 and the skin-facing side 12 of the guard plate 10 in the pressure relenting zone 30 and the pressure restoring zone 36 (referred to herein as the change in height) is 0.1 mm. In some examples, the change in height may be more than 0.1 mm such as 0.3 mm, or more than 0.3 mm. In other words, the peak height at the rising point 38 may be more than 0.1 mm, or more than 0.3 mm in a preferred example. The larger the change in height at the transition 32, the more pronounced the effect of the pressure relenting zone 30 will be in reducing the pressure which is applied to the skin locally, because a user's skin will be less likely to be able to follow the contours of the transition when the guard plate 10 is applied and run over the user's skin. Reducing the pressure applied to the skin in this region improves the hair cutting of the raised section 22, because the reduction in pressure allows hairs to stick up or reorientate from the user's skin towards the guard plate 10.

A plurality of apertures 48 are distributed on the raised section 22 on the pressure restoring zones 36 only (best shown in FIG. 1 in which the top portion 34 and the pressure restoring zones 36 are delineated by respective dashed lines indicating the tangent point 46). The apertures 48 are configured to capture hairs to be cut. In this example, the apertures 48 are circular and have a diameter of 300 microns. In other examples, the diameter may extend between a range of 200-400 microns or between 250-350 microns, or may be non-circular and have a dimension of up to 500 microns, and in yet further examples, the apertures may comprise different shapes and sizes. In some examples, the plurality of apertures may be distributed on both the pressure restoring zones and the top portion. Apertures in the pressure restoring zone are more effective at catching hairs than apertures in the top portion, due to the transition to the raised section and the pressure relenting zone.

In this example, the apertures 48 are evenly distributed across the pressure restoring zone 36 and at least within the first 1 mm of the pressure restoring zone 36 from the rising point 38. Having the apertures 48 within at least the first 1 mm of the pressure restoring zone is also more effective at catching hairs since this is within the first few hair diameters. The proportion of apertures 48 to total area of the plate in the pressure restoring zone in this example is approximately 40%. In other examples, the proportion of apertures 48 to total area may be more than 40%. The higher the proportion of apertures in the pressure restoring zone 36, the more likely that hairs will be caught in the apertures 48 for cutting. In other examples, the apertures may not be distributed across the whole of the pressure restoring portion. The proportion of apertures to plate material may apply for only the area in which the apertures are located, such as an area bounded by two aperture diameters from the centre of each aperture. It will be appreciated that in some examples, only one pressure restoring zone may comprise apertures.

The raised section 22 of the guard plate 10 does not extend beyond a raised envelope 24 (shown in FIG. 2) to reduce the risk of significantly impeding the cutting ability of the close-cutting teeth 16 when the guard plate 10 is passed over a user's skin in use. The raised envelope 24 is defined by a line passing through the edge 18 of the guard plate 10 and offset from a tangent at the edge 18 of the guard plate 10 by an angle, α, of 30 degrees. The tangent at the edge 18 of the guard plate 10 in this example is aligned with the surface of the pressure relenting zone 30 because the pressure relenting zone 30 is planar and extends from the close-cutting teeth 16. In some examples, the angle, a, of the raised envelope may be 25 degrees. Limiting the raised section 22 to within the raised envelope 24 reduces the negative impacts of the raised section on the performance of the close-cutting trimming teeth 16 which require constant contact with the skin.

In this example, the raised section 22 extends beyond a minimum envelope defined by a line passing through the edge 18 of the guard plate 10 and offset from a tangent at the edge 18 of the guard plate 10 by an angle of 5 degrees (not shown). Having the raised section extend beyond the minimum envelope helps to ensure that there is enough pressure applied to the skin on the raised envelope for the best cutting performance of the raised section.

Although it has been described that the guard plate 10 comprises a single integral plate, in some examples, the guard plate may comprise multiple plates which are fused, or otherwise attached, together.

It will also be appreciated that, in other examples when there is only one set of close-cutting teeth, there may be only a single pressure relenting zone and a raised section, a single transition between the pressure relenting zone and the raised section, and a single pressure restoring zone on the raised section. In some examples, the raised section (and therefore the transition and rising portion) do not extend the entire length along the longitudinal axis of the guard plate, but may be present only in some parts of the guard plate. Further, in some examples, there may be two sets of close-cutting teeth extending along the edges of the guard plate, which may exist in planes offset from one another (i.e. the two edges and sets of teeth may not be in the same plane), in which case the envelopes for the raised section are defined at each respective edge.

Although, the guard plate 10 has been defined as extending along a longitudinal axis 50, in some examples, it may extend along a curved line such that the guard plate extends with a curvature.

FIG. 3 shows an exploded view of a blade set 100, comprising the guard plate 10 and a cutting plate 110, which is configured to be received on the guard plate 10 on the blade-facing side 14 of the guard plate 10.

The cutting plate 110 comprises cutting teeth 112 on opposing edges which are configured to cooperate with the close-cutting trimming teeth 16 on opposing sides of the guard plate 10 to trim hairs. The cutting plate 110 further comprises a plurality of blades 114 extending from a face of the cutting plate 110 towards the guard plate 10. The blades 114 each have a profile corresponding to the profile of the raised section 22 of the guard plate 10 such that the blades 114 are configured to cooperate with the apertures 48 in the guard plate 10 to cut hairs.

The blade set 100 in this example further comprises a guard support plate 200 which is configured to be received by the guard plate 10 on the blade-facing side 14, between the close-cutting teeth 16 and the bent back portion of the guard plate 10, so as to support the bent back portion of the guard plate 10, and thereby to support the close-cutting trimming teeth 16. The guard support 200 also comprises a plurality of teeth 202 which are configure to align with the close-cutting teeth 16 of the guard plate 10, and which are configured to cooperate with the teeth 112 of the cutting plate 110 to cut hairs.

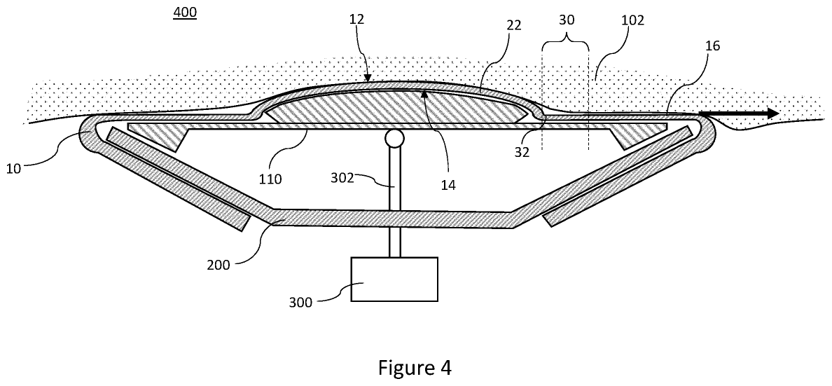

The guard support 200 comprises a slot 204 through the thickness of the plate forming the guard support 200. The slot 204 extends along a longitudinal direction which is parallel to the longitudinal axis 50 of the guard plate 10 when the blade set 100 is assembled. The slot 204 is configured to receive a lever 302 connected to a driving unit 300 (shown in FIG. 4).

In other examples, the bent-back portion may connect to the blade-facing surface of the guard plate to form a buttress for each close-cutting tooth, instead of having the guard support. Both the guard support and the buttresses reinforce the close-cutting teeth 16, allowing the plate at the close-cutting teeth 16 to be thinner to reliably providing a close shave in use.

FIG. 4 shows a cutting assembly 400 comprising the blade set 100 and the driving unit 300 being applied to a user's skin. The blade set 100 comprises the guard plate 10, the cutting plate 110 and the guard support 200, as is shown being applied to skin 102 to shave or trim the hair on the skin 102, with the skin-facing side 12 of the guard plate 10 running over the skin 102 of a user.

The driving unit 300 comprises a lever 302 which is received through the slot 204 of the guard support 200 and which is pivotably connected to the cutting plate 110. The driving unit 300 is thereby configured to oscillate the cutting plate 110 with respect to the guard plate 10 to cut hair at the close-cutting trimming teeth 16 and at the apertures 48.

FIG. 4 shows the cutting assembly 400 being passed over a user's skin 102 toward the right side of the page (shown by an arrow). The user's skin 102 flows over the guard plate 10 in contact with the close-cutting teeth 16, and over the raised section 22 of the guard plate 10. It can be seen from FIG. 4 that the skin 102 does not follow the contour of the skin-facing side 12 of the guard plate 10 at the pressure relenting zone 30 because of the transition 32 to the raised section 22. Therefore, in the pressure relenting zone 30, there is lower or no pressure on the skin 102 from the guard plate 10. Due to the lower, or absence of, pressure in the pressure relenting zone 30, the hairs on the skin 102 protrude towards the guard plate 10 and are captured by the apertures 48 in the pressure restoring zone 36 of the raised section 22. The apertures must be placed in the pressure restoring zone 36 (i.e. between the rising point and 1 mm beyond that point towards the top section 34) so as to be able to capture the hairs from the pressure relenting zone 30 reliably.

Although the apertures 48 have been described as being within at least the first 1 mm of the raised section 22 from the rising point 38 (i.e. the peak height from the pressure relenting line 44), in some examples, the apertures may be in the first 300 microns of the raised section from the rising point (e.g. within one hair's width from the rising point). The closer the apertures 48 on the raised section 22 are to the rising point 38 of the guard plate 10, the more likely they are to catch the hairs.

The symmetrical nature of the cutting assembly 400 with the guard plate 10 means that the cutting assembly 400 can be used to cut hairs in either direction.

The cutting assembly 400 can be mounted on a handle to provide a hair cutting appliance which can be easily manipulated as required by a user.

Variations to the disclosed embodiments can be understood and effected by those skilled in the art in practicing the principles and techniques described herein, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A guard plate for a blade set for a hair cutting appliance, the guard plate comprising a skin-facing side and an opposing blade-facing side:
a plurality of close-cutting trimming teeth distributed in a longitudinal direction along an edge of the guard plate, each tooth extending from the edge of the guard plate to a respective tip, the guard plate having a thickness of less than 120 microns at the close-cutting trimming teeth;
a raised section comprising a curved shape in a plane perpendicular to the longitudinal direction such that it is raised from the teeth towards the skin-facing side of the guard plate, wherein the curved shape of the raised section does not extend beyond a 30-degree envelope defined by a line passing through the edge of the guard plate and offset from a tangent at the edge of the guard plate by 30 degrees;
a pressure relenting zone between the teeth and the raised section defining a continuous surface, wherein there is a transition between the pressure relenting zone and the raised section such that, when the guard plate is passed over a user's taut skin, the skin does not directly follow the contours of the transition thereby locally reducing pressure from the skin;
wherein a plurality of apertures are distributed on the raised section at least within a pressure restoring zone of the raised section, the pressure restoring zone being defined between a rising point and a tangent point, wherein the rising point is where a perpendicular distance from the skin-facing surface of the guard plate to a pressure relenting line peaks, wherein the pressure relenting line is defined by a tangent of the raised section in a plane perpendicular to the longitudinal direction, the tangent passing through the edge of the guard plate, and wherein the tangent point is on the raised section at the tangent of the pressure relenting line.

2. A guard plate according to claim 1, wherein the plurality of apertures are distributed on the raised section at least within the first 1 mm of the pressure restoring zone from the rising point.

3. A guard plate according to claim 1, wherein the surface of the guard plate at the transition comprises a change in height of at least 0.1 mm, the height being defined by the perpendicular distance between the skin-facing surface and the pressure relenting line.

4. A guard plate according to claim 1, wherein the plurality of apertures are further distributed across a top portion of the raised section adjacent to the pressure restoring zone of the raised section.

5. A guard plate according to claim 1, wherein the pressure relenting zone is planar.

6. A guard plate according to claim 1, wherein the guard plate comprises a plurality of close-cutting trimming teeth distributed in the longitudinal direction along opposing edges of the guard plate;
wherein there are a pair of pressure relenting zones located on either side of the raised section, each pressure relenting zone disposed between the raised section and the teeth along one edge of the guard plate; and
wherein the raised section comprises atop portion flanked by two pressure restoring zones, each pressure restoring zone adjacent to a pressure relenting zone, wherein the raised section comprises a plurality of apertures distributed in at least the two pressure restoring zones.

7. A guard plate according to claim 1, wherein the guard plate is formed a single integral plate.

8. A guard plate according to claim 1, wherein the curved shape of the raised section extends beyond a 5-degree envelope defined by a line passing through the edge of the guard plate and offset from a tangent at the edge of the guard plate by 5 degrees.

9. A guard plate according to claim 1, wherein each tooth extends from the edge to a tip, and at the tip, each tooth is bent towards the blade-facing surface and directed back towards the edge (18), connecting to the blade-facing surface to form a buttress to reinforce the tooth.

10. A guard plate according to claim 1, wherein the apertures are evenly distributed across the pressure restoring zone.

11. A guard plate according to claim 1, wherein the proportion of the area of apertures to total area of the pressure restoring zone is at least 40%.

12. A blade set for a hair cutting appliance comprising the guard plate according to claim 1, and a cutting plate considered to be received on the guard plate and to cooperate with the guard plate to cut hair.

13. A cutting assembly comprising a blade set according to claim 12 and a driving unit configured to oscillate the cutting plate with respect to the guard plate.

14. A hair cutting appliance comprising a cutting assembly according to claim 13 mounted on a handle.
